(19) United States
(12) Patent Application Publication
(10) Pub. No.: US 2013/0223202 A1
(43) Pub. Date: Aug. 29, 2013

(54) OPTICAL PICKUP

(71) Applicant: HITACHI MEDIA ELECTRONICS CO., LTD., (US)

(72) Inventors: Yasushi KINOSHITA, Hitachinaka (JP); Fumihito ICHIKAWA, Yokohama (JP); Takashi TAYAMA, Fujisawa (JP); Toshio OSADA, Chigasaki (JP); Yoshiro KONISHI, Yokohama (JP)

(73) Assignee: HITACHI MEDIA ELECTRONICS CO., LTD., Iwate (JP)

(21) Appl. No.: 13/778,189

(22) Filed: Feb. 27, 2013

(30) Foreign Application Priority Data
Feb. 29, 2012 (JP) 2012-042684

(51) Int. Cl. G11B 7/22

(52) U.S. Cl. CPC G11B 7/22
USPC 369/120

(57) ABSTRACT

In a photo-detector position adjustment/bonding process, it has been necessary for a worker to hold a dangling photo-detector and plate with a tool such as tweezers, and chuck the photo-detector and plate onto an adjustment jig. Because the chucking onto the adjustment jig is performed by a manual operation, productivity is low and it has been difficult to decrease the process standard time (ST). In order to substantially stabilize the standby position of the photo-detector, a pressing force is provided by the reaction force of a flexible substrate in the direction of an optical pickup, and the contacting surfaces of an optical pickup case and the plate are prevented from sliding and displaced from each other.

### BACKGROUND

1. Technical Field

The embodiments discussed herein relate to an optical pickup.

2. Related Art

An optical pickup includes a plurality of parts, such as a laser source, optical parts including lenses and mirrors, and a photo-detector, which are mounted on a pickup case. Laser light emitted by the laser source is irradiated onto a recording layer of an optical disc via the optical parts. Reflected light from the recording layer is guided via the optical parts to the photo-detector. The optical pickup controls a lens actuator or performs information reproduction, for example, on the basis of the amount of laser light detected by the photo-detector.

During the assembly of the optical pickup, the photo-detector is attached to the pickup case in two processes. In the first process, a flexible substrate with the photo-detector connected and mounted in advance is attached onto the optical pickup case. In the second process, position adjustment is performed such that a detection surface of the photo-detector can be irradiated with laser light, while a plate fixedly holding the photo-detector is held with a jig, and then the adjusted position is fixed with an adhesive.

In the process of attaching the flexible substrate, the flexible substrate is bent at right angles. At this time, the flexible substrate and the photo-detector mounted thereon tend to rise due to the bending reaction force of the flexible substrate, resulting in a destabilized holding position. This adversely affects the workability of the operation for chucking the photo-detector and the plate onto the adjustment jig in the photo-detector position adjustment/bonding process.

A related background technology is discussed in JP Patent Publication (Kokai) No. 2005-353198. According to this publication, a flexible substrate includes a hanger portion for hooking the flexible substrate onto the housing. The housing includes a hook portion corresponding to the hanger portion. When installing the flexible substrate on the housing, the hanger portion is hooked onto the hook portion, whereby the flexible substrate is bent such that a folded portion is formed in the flexible substrate. During the assembly of the optical pickup, the rising of the flexible substrate due to the bending reaction force of the flexible substrate is prevented by the hooking

Another background technology is discussed in JP Patent Publication (Kokai) No. 2006-216131. According to the publication, as an optical element attached to an attaching portion of a base member, an optical intensity detection sensor is mounted in an element attaching area of a flexible wiring substrate. The element attaching area of the flexible wiring substrate is folded toward a guiding area, and the folded portion is housed in a space between the attaching portion of the base member and a backup portion facing the attaching portion, so that the element attaching area can be biased onto the attaching portion by the resilient force provided by the folded portion of the flexible wiring substrate. Thus, the optical intensity detector is positioned by being pressed onto the optical pickup case by the bending reaction force of the flexible substrate.

### SUMMARY

Conventionally, during the assembly of the optical pickup, after the process of attaching the flexible substrate, the photo-detector and the plate are transported between processes with the photo-detector and the plate hanging from the flexible substrate. Thus, in the photo-detector position adjustment/bonding process, the operator needs to hold the hanging photo-detector and plate with a tool such as tweezers and chuck the photo-detector and plate onto the adjustment jig. Because the operation for chucking the photo-detector and plate onto the adjustment jig is manually performed, productivity is low and it has been difficult to decrease the process standard time (ST).

Further, when the photo-detector and the plate are moved between the processes while hanging from the flexible substrate, the photo-detector or the plate may become caught by the jig or the like during transport, resulting in problems such as damaging the flexible substrate or causing the photo-detector to be peeled from the flexible substrate.

The technologies according to the related art, such as the hooking of the flexible substrate or the pressing of the element attaching area onto a recess portion formed in the optical pickup case in which the optical part is fitted, may be effective in preventing damage to the flexible substrate. However, the hooking of the flexible substrate or an operation for removing the optical part from the recess portion has to be performed manually, so that it cannot be expected that the technologies will be effective in decreasing the process standard time (ST).

Accordingly, the present invention provides an optical pickup such that the process standard time (ST) can be decreased.

In order to solve the above problems, the configurations described in the claims are adopted, for example.

While the present application includes a plurality of means for solving the problems, one example is an optical pickup including a photo-detector; a plate holding the photo-detector; a flexible substrate connected to the photo-detector; an optical pickup case; and an adhesive filling a gap between the optical pickup case and the plate. The optical pickup case includes a beam disposed closer to an outer peripheral side than the plate. The beam and the plate include surfaces facing each other, with an uneven profile formed on each of the surfaces. The uneven profiles are spaced apart from each other.

According to an embodiment, an optical pickup such that the process standard time (ST) can be decreased is provided.

According to an embodiment, in order to substantially stabilize the standby position of the photo-detector after a flexible substrate attaching process, for example, a pressing force is produced by the reaction force of the flexible substrate in the direction of the optical pickup, and an anti-slipping measure is taken such that no slipping occurs on the contacting surfaces of the optical pickup case and the plate.

Further, according to an embodiment, the photo-detector and the plate can be placed at a substantially predetermined standby position, so that the chucking onto the adjustment jig can be automatically performed during the photo-detector position adjustment/bonding process, for example. Thus, a significant decrease in the standard time (ST) can be achieved, and an optical pickup with high productivity can be provided. Further, damage to the flexible substrate can be prevented, so that an improvement in production efficiency can be expected.

Other problems, configurations, and effects will become apparent from the following description of embodiments.

### BRIEF DESCRIPTION OF DRAWINGS

FIG. 1 illustrates a configuration of an optical pickup;

FIG. 2 illustrates a detailed structure around a photo-detector;

FIG. 3 is an example of a photo-detector attaching process;

FIG. 4 illustrates a flexible substrate attaching process;

FIG. 5 illustrates a provisional photo-detector/plate attaching process;

FIG. 6 illustrates a photo-detector position adjustment process;

FIG. 7 illustrates an adhesive applying process;

FIG. 8 illustrates a UV irradiation process;

FIG. 9 illustrates a modification of the present embodiment;

FIG. 10 illustrates a modification of the present embodiment; and

FIG. 11 illustrates a modification of the present embodiment.

### DETAILED DESCRIPTION

In the following, an embodiment will be described with reference to the drawings. Elements designated with similar reference signs have similar functions throughout the drawing figures and their description may be omitted.

### First Embodiment

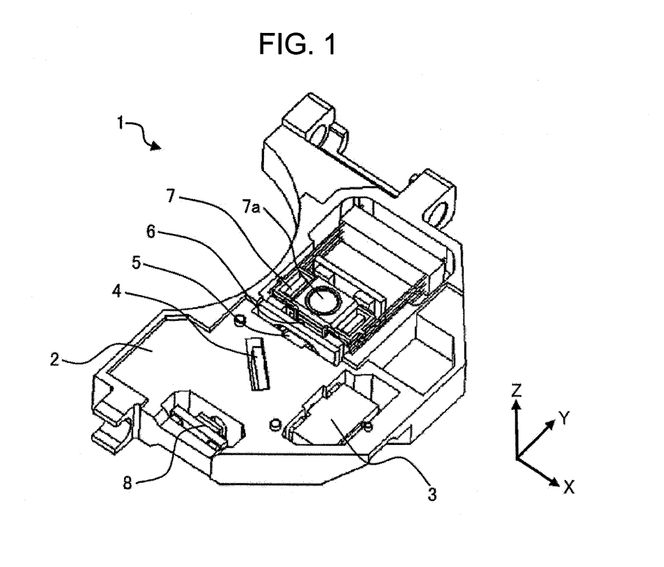

An optical pickup according to an embodiment will be described. FIG. 1 illustrates a configuration of an optical pickup 1 according to the present embodiment. The optical pickup 1 includes a pickup case 2; a laser source 3; a beam splitter 4; a collimator lens 5; a reflection mirror 6; an objective lens actuator 7; an objective lens 7a; and a photo-detector 8. A disc radial direction, a disc circumferential direction, and a disc vertical direction are indicated by X, Y, and Z, respectively.

The optical pickup 1 is configured such that the laser source 3, the beam splitter 4, the collimator lens 5, the reflection mirror 6, the objective lens 7a, and the photo-detector 8 are mounted on the pickup case 2. In order to deal with a plurality of optical disc standards, such as CD, DVD, and BD (Blu-ray Disc), a plurality of the laser sources 3, beam splitters 4, collimator lenses 5, reflection mirrors 6, objective lenses 7a, and photo-detectors 8 may be mounted.

The pickup case 2 is a base member for mounting the optical parts. In order to ensure strength and enable formation of a complex shape, the pickup case 2 may be made by forming a metal-based material, such as a zinc alloy or a magnesium alloy, or a resin-based material, such as a polyphenylene sulfide resin mixed with a glass filler. The laser source 3 includes a semiconductor laser element that emits laser light of a specific wavelength designated by the particular optical disc standard, such as CD, DVD, or BD. The beam splitter 4 is an optical part for dividing the laser light into transmitted light and reflected light. For example, the beam splitter 4 is a prism including two right-angle prisms affixed to each other, or a mirror of a glass plate with an optical film formed thereon. The collimator lens 5 is an optical lens for converting divergent rays of the laser light into parallel rays. The reflection mirror 6 is a mirror that totally reflects the laser light. The reflection mirror 6 includes a reflecting surface which is inclined such that the laser light can be vertically bent from inside the pickup case 2 of the optical pickup 1 toward the optical disc, which is not illustrated. The objective lens actuator 7 includes an electromagnetic actuator that drives the objective lens 7a in at least the direction perpendicular to the disc surface (Z-direction) and the radial direction of the disc (X-direction). The objective lens 7a is a lens for focusing the parallel rays of laser light on the recording surface of the optical disc. The photo-detector 8 is a photoelectric conversion element that produces an electric signal in accordance with the amount of laser light that is incident on a detection surface of the element. The detection surface of the photoelectric conversion element may be divided into several regions so that the amount of laser light incident on the respective regions can be detected individually.

An operation of the optical pickup according to the present embodiment will be described.

The laser light emitted by the laser source 3 is reflected by the beam splitter 4 and then reaches the collimator lens 5, by which the laser light is converted into parallel rays. The laser light is further totally reflected by the reflection mirror 6 toward the optical disc and focused by the objective lens 7a into a beam spot on the recording surface of the optical disc. The optical pickup 1 performs recording and reproduction of information in the optical disc via the beam spot. For recording, the laser source 3 is switched on and off on the basis of the recording information, whereby the beam spot is turned on and off such that recording pits are formed on the optical disc, thus writing information. For reproduction, the beam spot is irradiated onto the recording pits on the optical disc, and the laser light reflected by the recording pits is received by the objective lens 7a. The received laser light then travels in the opposite direction from the outgoing path, i.e., through the reflection mirror 6, the collimator lens 5, and the beam splitter 4 in that order, and eventually irradiates the detection surface of the photo-detector 8. The photo-detector 8 reads the recording information in the optical disc depending on the brightness of the laser light incident on the detection surface. The photo-detector 8 also detects an optical axis deviation on the basis of the amounts of laser light from the divided regions of the detection surface for feedback-control of the objective lens actuator 7.

The detailed structure around the photo-detector 8 according to the present embodiment will be described.

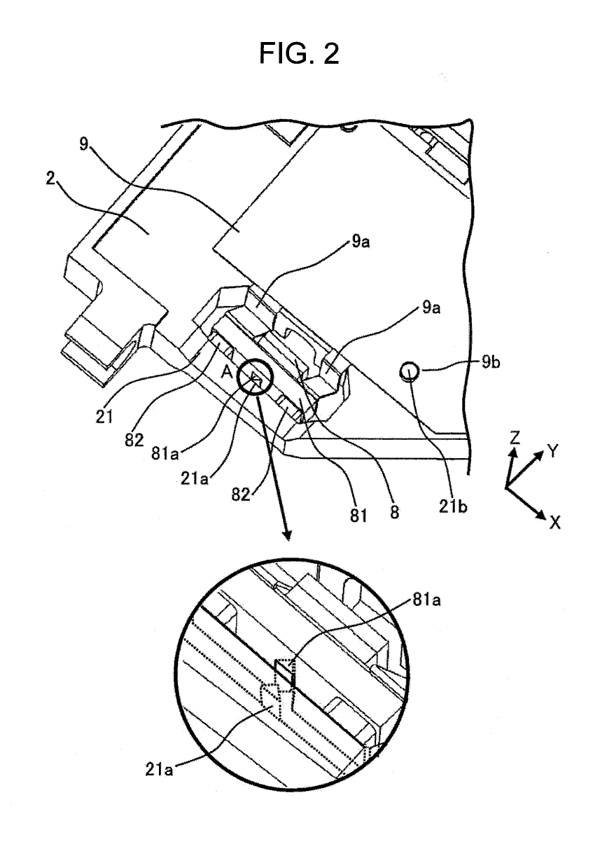

FIG. 2 illustrates an example of the detailed structure around the photo-detector according to the present embodiment.

FIG. 2 illustrates the pickup case 2, a beam 21, an uneven profile (protrusion) 21a, a boss 21b, the photo-detector 8, a plate 81, an uneven profile (groove) 81a, an adhesive 82, a flexible substrate 9, arms 9a, and a boss hole 9b.

The optical pickup case 2 includes the beam 21, which is located on a rear side of the detection surface of the photo-detector 8. The beam 21 is passed on the rear side of the detection surface of the photo-detector 8. The photo-detector 8 is enclosed by the beam 21. The uneven profile 21a formed on a surface of the beam 21 facing the rear side of the detection surface of the photo-detector 8. The boss 21b is a protrusion for positioning the flexible substrate 9. The boss 21b may be disposed at a plurality of locations such that the rotation of the flexible substrate 9 can be prevented.

The plate 81 is a reinforcing plate for protecting the point of contact between the flexible substrate 9 and the photo-detector 8. The plate 81 may include a glass-epoxy substrate or a metal plate of stainless steel or aluminum, with a size slightly larger than the photo-detector 8. Because the position of the photo-detector 8 is adjusted with the plate 81 held by an adjustment jig, the plate 81 may include a protrusion, a cut-out, or a hole for facilitating the holding of the plate 81 by the adjustment jig. The uneven profile 81 a is formed on a surface of the plate 81 opposite to the surface on which the photo-detector 8 is mounted, the uneven profile 81a facing the uneven profile 21a formed on the beam 21 of the pickup case 2.

The adhesive 82 is an ultraviolet-curing adhesive. The adhesive 82 is applied in a region between the plate 81 and the optical pickup case 2 in a bridging manner. The bonding may take place inside or outside with respect to the photo-detector 8.

The flexible substrate 9 is a substrate for connection of power supply and signal lines to the photo-detector 8. The flexible substrate 9 may include a substrate of a flexible material, such as polyimide, with copper wiring. The flexible substrate 9 and the photo-detector 8 may be electrically connected by soldering. The flexible substrate 9 is bifurcated across the photo-detector 8 into the arms 9a. The arms 9a are folded and inserted in the gap between the plate 81 and the optical pickup case 2. The boss hole 9b is used for positioning or fixing the flexible substrate 9 by being fitted on the boss 21b.

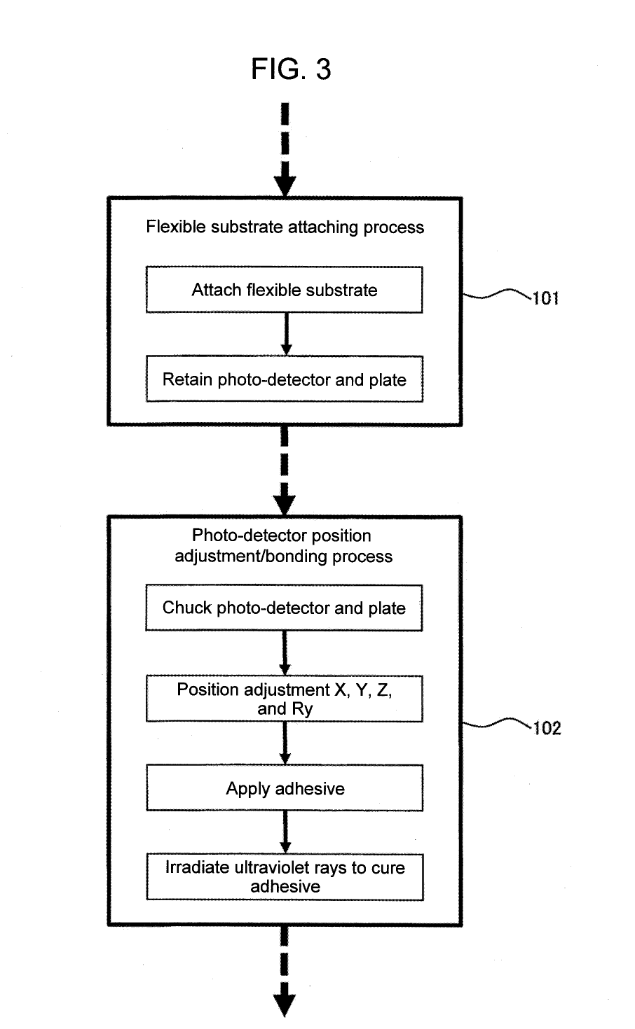

A process of attaching the photo-detector 8 according to the present embodiment will be described with reference to FIGS. 3 to 8.

FIG. 3 illustrates the process of attaching the photo-detector 8. The illustrated process is that for attaching the photo-detector 8 according to the present embodiment; illustration of other processes related to the assembly of parts is omitted.

During the assembly of the optical pickup 1, the photo-detector 8 is attached to the pickup case 2 through two processes 101 and 102.

The process 101 is a process for attaching the flexible substrate 9. The photo-detector 8 is connected to the flexible substrate 9 by soldering in advance, and the connected portion is reinforced by the plate 81. The bifurcated portions of the flexible substrate 9, i.e., the two arms 9a, are folded in a bellows-like fashion by forming.

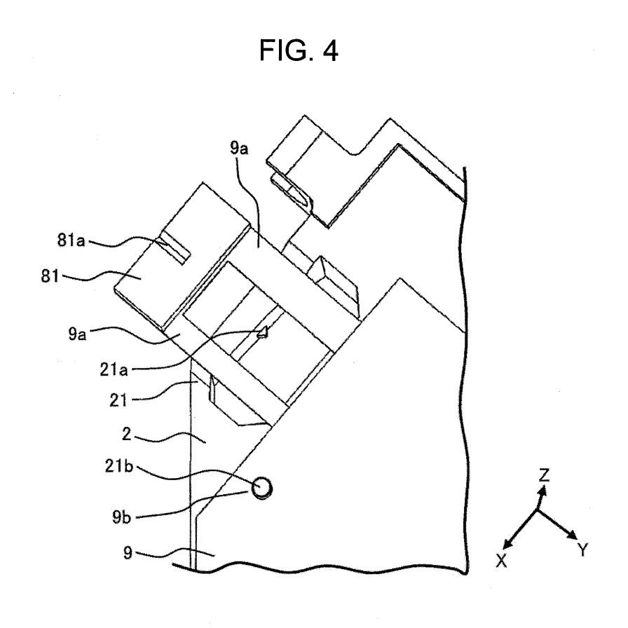

Next, as illustrated in FIG. 4, in order to attach the flexible substrate 9, the flexible substrate 9 is positioned by fitting the boss hole 9b of the flexible substrate 9 on the positioning boss 21b of the optical pickup case 2. After the positioning, the flexible substrate 9 is fixed in place by using screws, for example. Additional fixing may be provided by an adhesive tape or an adhesive as needed. Next, the photo-detector 8 (which is on the lower side of the plate 81 in FIG. 4 and not illustrated) and the plate 81 are retained. First, the photo-detector 8 and the plate 81 are held with a tool such as tweezers. Then, the uneven profile 81a on the plate 81 and the uneven profile 21 a on the beam 21 of the optical pickup case 2 are fitted onto each other, while the arms 9a of the flexible substrate 9 are folded.

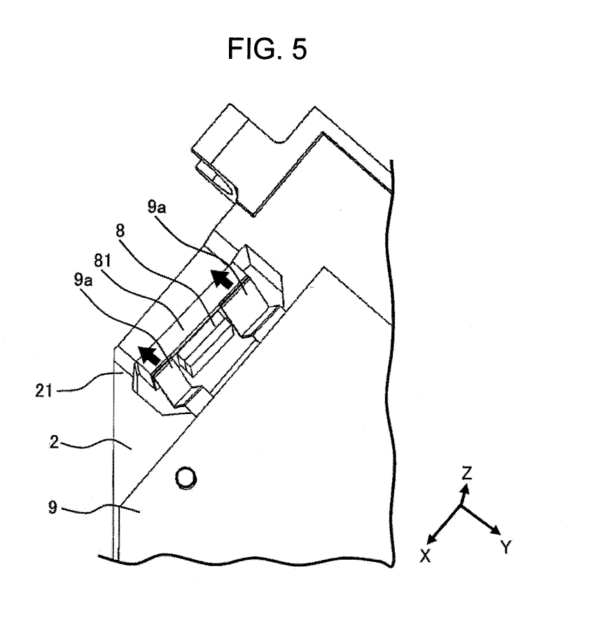

As illustrated in FIG. 5, because the arms 9a of the flexible substrate 9 are folded, the flexible substrate 9 exerts a bending reaction force such that the plate 81 is pressed in the direction of the rear side of the photo-detector 8. Due to such pressing force and the frictional force between the fitted portions and the contacting surfaces, the photo-detector 8 and the plate 81 can be prevented from sliding in a left-right direction and positioned or retained with high reproducibility. Thus, after the flexible substrate attaching process 101, the photo-detector 8 and the plate 81 can be transported between processes in a retained state.

The process 102 illustrated in FIG. 3 is a position adjustment/bonding process for the photo-detector 8. First, the plate 81 is automatically chucked by the adjustment jig. During the automatic chucking, it is important that the photo-detector 8 and the plate 81 are in a substantially stabilized standby position. This is ensured by the positioning/retention performed at the end of the flexible substrate attaching process 101.

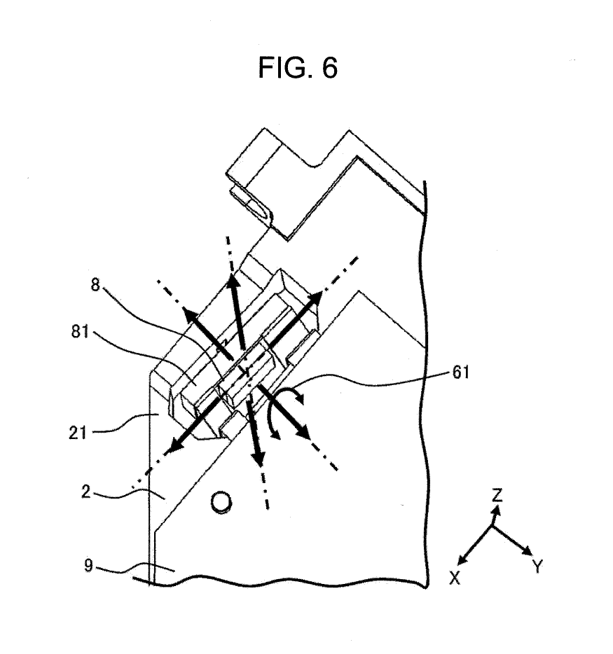

Next, as illustrated in FIG. 6, the position of the photo-detector 8 is adjusted by using the adjustment jig. Specifically, three-axial position adjustment is performed in the optical axis direction of the photo-detector 8 (Y-direction) and the longitudinal and lateral directions (X-direction and Z-direction) in a plane perpendicular to the optical axis, and a rotation angle adjustment is performed about the optical axis (RY-direction 61). By the position adjustment, the uneven profile 81a of the plate 8 and the uneven profile 21a of the beam 21 are spaced apart from each other.

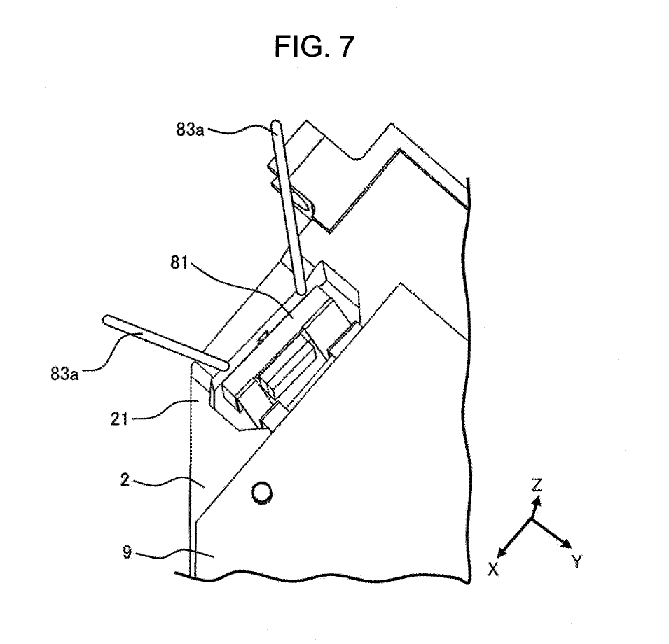

After position adjustment, the adhesive 82 is applied between the plate 81 and the optical pickup case 2 by using a dispenser 83a, for example, as illustrated in FIG. 7.

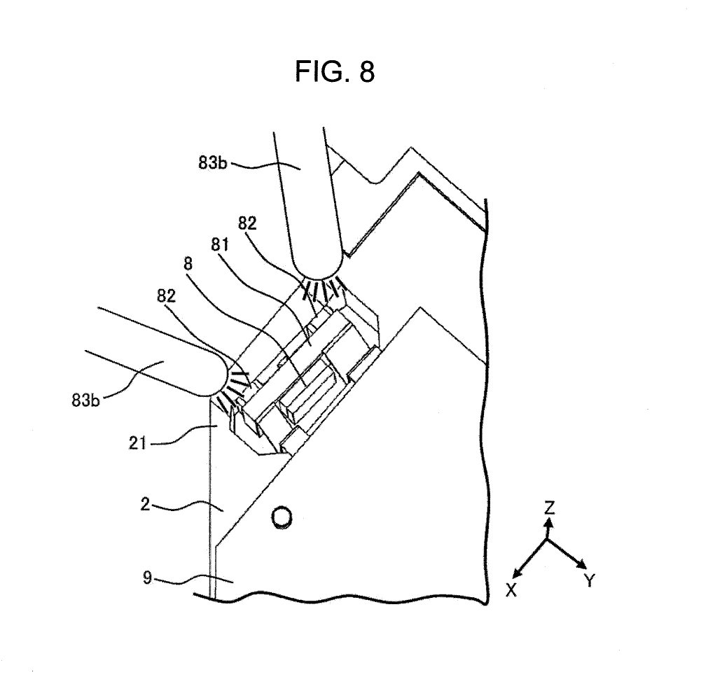

Then, as illustrated in FIG. 8, the adhesive 82 is cured by irradiating the adhesive 82 with ultraviolet ray by using an ultraviolet ray irradiation apparatus 83b. After the adhesive 82 is cured, the chucking by the adjustment jig is released and the process ends.

Conventionally, it has been difficult to perform the automatic chucking by the adjustment jig because of the unstable standby position due to the photo-detector 8 and the plate 81 hanging from the flexible substrate 9. In order to implement the automatic chucking in the position adjustment/bonding process 102 for the photo-detector 8, the photo-detector 8 and the plate 81 need to be located at generally the same position. According to the present embodiment, the standby position reproducibility is increased by the uneven profile 81a on the plate 81 and the uneven profile 21a on the beam 21 of the optical pickup case. The uneven profile 81a and the uneven profile 21a may have a triangular, trapezoidal or semicircular cross-sectional shape such that the plate 81 and the beam 21 can be easily spaced apart from each other after the chucking. According to the related art, the flexible substrate is hooked, or the recess with the optical part fitted therein is formed in the optical pickup case and pressed. In these cases, however, the operation for unhooking or detaching the optical part from the recess also needs to be automated, which would result in a jig configuration for position adjustment of the photo-detector which is very difficult to implement.

According to the present embodiment, the uneven profile 21a is formed on the beam of the optical pickup case 2 while the uneven profile 81a is formed on the plate 81 that fixedly holds the photo-detector 8. Thus, the standby position of the photo-detector 8 and the plate 81 is stabilized, so that the automatic chucking by the adjustment jig can be implemented. Accordingly, the optical pickup 1 such that the standard time (ST) for the photo-detector position adjustment process 102 can be decreased can be provided.

The present invention is not limited to the foregoing embodiment and may include various modifications. The foregoing detailed description has been presented for the purposes of illustration and description, and it is not intended to be exhaustive or to limit the subject matter described herein to the precise form disclosed. A part of the configuration of one embodiment may be substituted by the configuration of another embodiment, or the configuration of the other embodiment may be added to the configuration of the one embodiment. With respect to a part of the configuration of an embodiment, additions, deletions, or substitutions from other configurations may be made.

### Second Embodiment

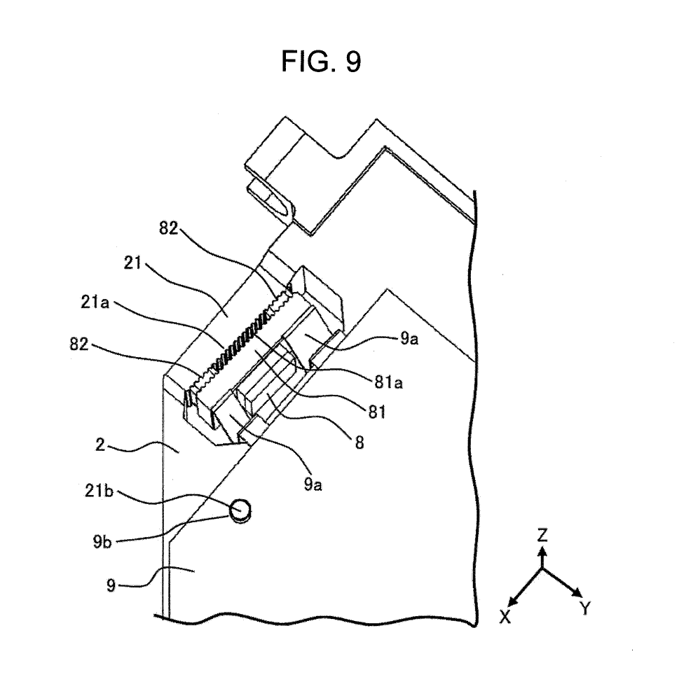

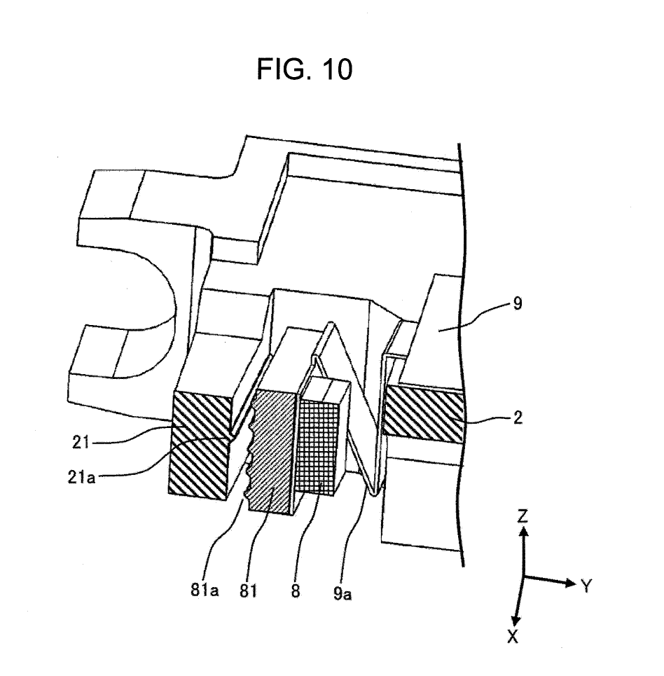

The optical pickup according to a modification will be described with reference to FIGS. 9 and 10. FIG. 9 illustrates the optical pickup according to the present embodiment. The configuration and operation of the optical pickup are similar to the first embodiment. According to the present embodiment, variations of the surface shape of the beam 21 of the optical pickup case 2 and the surface shape (corresponding to the uneven profile 81a) of the plate 81 fixedly supporting the photo-detector 8 will be described.

As illustrated in FIG. 9, the beam 21 of the optical pickup case 2 and the plate 81 have corrugated surfaces, respectively. By forming the corrugated surfaces and fitting the corrugated surfaces onto each other during the positioning of the photo-detector 8 and the plate 81, the photo-detector 8 and the plate 81 can be prevented from sliding in the direction of the corrugation. The direction of the corrugation may be vertical or lateral. When the corrugation is aligned in the vertical direction (Z-direction) as illustrated in FIG. 9, the sliding of the photo-detector 8 and the plate 81 in the left-right direction (X-direction) can be suppressed, so that improved position reproducibility in the left-right direction (X-direction) can be obtained. When the corrugation is aligned in the lateral direction (X-direction) as illustrated in FIG. 10, the sliding of the photo-detector 8 and the plate 81 in the upper-lower direction (Z-direction) can be suppressed, so that the photo-detector 8 and the plate 81 can be effectively prevented from falling out of the standby position, while improved position reproducibility in the upper-lower direction (Z-direction) can be obtained. Further, by forming the corrugation in a lattice (vertically and laterally), the sliding of the photo-detector 8 and the plate 81 in the upper-lower and left-right directions (X- and Z-directions) can be suppressed, whereby the photo-detector 8 and the plate 81 can be effectively prevented from falling out while improved upper-lower and left-right (X- and Z-directional) position reproducibility can be obtained. The concave-convex profile of the corrugation may have a triangular, trapezoidal, or semicircular cross section such that the releasing after chucking can be facilitated. The size of the corrugation may be set within an adjustment range for the photo-detector 8.

According to a modification, a plurality of spike-like protrusions (corresponding to the uneven profile 21a) may be provided to the beam 21, while grooves may be provided in the surface of the plate 81. In this case, sliding can be prevented as the spike-like protrusions are meshed with the grooves in the plate 81.

In these configurations, by applying the adhesive 82 onto the corrugated portions, the protrusion portion, or the groove portion for bonding, the area of adhesion by the adhesive 82 can be increased and therefore increased bonding strength can be achieved, in addition to preventing the sliding.

According to the present embodiment, the beam 21 of the optical pickup case 2 and the plate 81 include the corrugated surfaces or the surfaces with protrusions or grooves such that the displacement of the photo-detector 8 and the plate 81 can be suppressed. As a result, the standby position can be stabilized and the automatic chucking by the adjustment jig can be performed. Thus, the optical pickup such that the standard time (ST) for the photo-detector position adjustment/bonding process 102 can be decreased can be provided.

The present invention is not limited to the foregoing embodiment and may include various modifications. The foregoing detailed description has been presented for the purposes of illustration and description, and it is not intended to be exhaustive or to limit the subject matter described herein to the precise form disclosed. A part of the configuration of one embodiment may be substituted by the configuration of another embodiment, or the configuration of the other embodiment may be added to the configuration of the one embodiment. With respect to a part of the configuration of an embodiment, additions, deletions, or substitutions from other configurations may be made.

### Third Embodiment

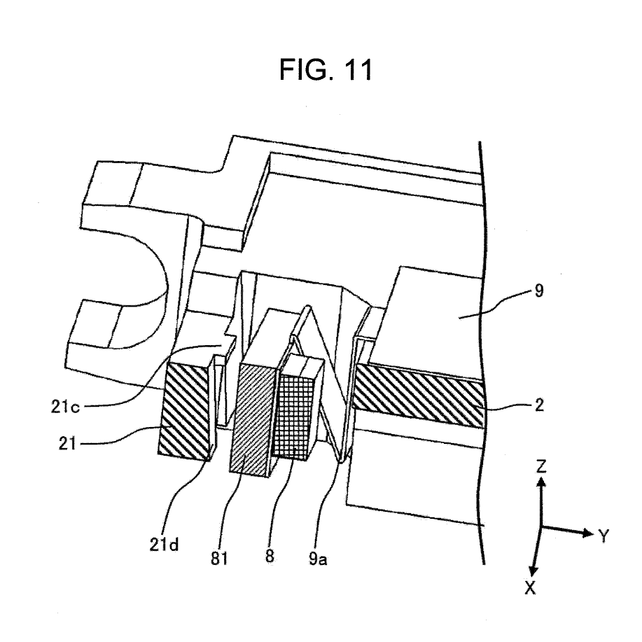

The optical pickup according to a modification will be described with reference to FIG. 11. The configuration and operation of the optical pickup are similar to the first embodiment.

According to the present embodiment, the beam 21 of the optical pickup case 2 includes an inclined surface 21d inclined with an increasing opening from the bottom surface toward the upper surface of the optical pickup 1, with a step 21c formed at the edge of the inclined surface 21d. The opposite surface of the plate 81 may be flat.

According to the present embodiment, the plate 81 is pressed onto the inclined surface 21d of the beam 21 by the bending reaction force of the bent arms 9a of the flexible substrate 9. Thus, the plate 81 tends to be easily displaced toward the upper surface of the optical pickup 1 along the slope of the inclined surface 21, whereby the direction in which the photo-detector 8 and the plate 81 may fall off is limited to one direction. Further, an end surface of the plate 81 is engaged with the step 21c at the edge of the inclined surface 21d such that the displacement of the plate 81 is regulated. Accordingly, the photo-detector 8 and the plate 81 can be prevented from falling out.

Further, according to the present embodiment, the upper surface of the beam 21 is provided with an opening by the inclined surface 21d. Thus, the photo-detector 8 and the plate 81 can be easily loaded at a predetermined position during the positioning/retaining of the photo-detector 8 and the plate 81 at the end of the flexible substrate attaching process 101.

According to the present embodiment, the beam 21 of the optical pickup case 2 includes the inclined surface 21d that is opened toward the upper surface of the optical pickup 1, with the step 21c disposed at the edge of the inclined surface 21d. Thus, the standby position of the photo-detector 8 and the plate 81 is stabilized, so that the automatic chucking by the adjustment jig can be performed. Accordingly, the optical pickup such that the standard time (ST) for the photo-detector position adjustment/bonding process 102 can be decreased can be provided.

The present invention is not limited to the foregoing embodiment and may include various modifications. The foregoing detailed description has been presented for the purposes of illustration and description, and it is not intended to be exhaustive or to limit the subject matter described herein to the precise form disclosed. A part of the configuration of one embodiment may be substituted by the configuration of another embodiment, or the configuration of the other embodiment may be added to the configuration of the one embodiment. With respect to a part of the configuration of an embodiment, additions, deletions, or substitutions from other configurations may be made.

For example, according to the present embodiment, the inclined surface 21d is provided to the beam 21 of the optical pickup case 2, the step 21c is provided to the edge of the inclined surface 21d, and the plate 81 is provided with the flat surface. Conversely, the inclined surface may be provided to the plate 81, the step 21c may be provided to the edge of the inclined surface of the plate 81, and the beam 21 of the optical pickup case 2 may be provided with the flat surface. Further, the standby position of the photo-detector 8 and the plate 81 may be stabilized by using a material with anti-slipping surfaces (such as a material with large friction) for the surfaces of the beam 21 of the optical pickup case 2 and the plate 81 instead of, or in combination with, the uneven profiles on the respective surfaces or the slope. Namely, the standby position of the photo-detector 8 and the plate 81 can be stabilized by the beam of the optical pickup case that is passed on the rear side of the detection surface of the photo-detector. Thus, the optical pickup such that the process standard time (ST) can be decreased can be provided, for example.

### Reference Signs List

1 Optical pickup

2 Optical pickup case

3 Laser source

4 Beam splitter

5 Collimator lens

6 Reflection mirror

7 Objective lens actuator

7a Objective lens

8 Photo-detector

9 Flexible substrate

9a Arm

9b Boss hole

21 Beam

21a Uneven profile (protrusion)

21b Boss

21c Step

21d Inclined surface

81 Plate

81a Uneven profile (groove)

83 Adhesive

Flexible substrate attaching process

102 Photo-detector position adjustment/bonding process

X Disc radial direction

Y Disc circumferential direction

Z Disc vertical direction

What is claimed is:

1. An optical pickup comprising:
a photo-detector with a detection surface;
a plate holding the photo-detector;
a flexible substrate connected to the photo-detector;
an optical pickup case including a beam; and
an adhesive filling a gap between the optical pickup case and the plate,
wherein:
the beam is passed on a rear side of the detection surface of the photo-detector;
the beam and the plate include surfaces facing each other, each with a concave-convex shaped uneven profile; and
the concave-convex shaped uneven profiles are spaced apart from each other.

2. An optical pickup comprising:
a photo-detector with a detection surface;
a plate holding the photo-detector;
a flexible substrate connected to the photo-detector;
an optical pickup case including a beam; and
an adhesive filling a gap between the optical pickup case and the plate,
wherein:
the beam is passed on a rear side of the detection surface of the photo-detector;
the beam and the plate include surfaces facing each other, one of the surfaces of the beam and the plate including a protrusion and the other surface including a groove; and
the protrusion and the groove are spaced apart from each other.

3. An optical pickup comprising:
a photo-detector with a detection surface;
a plate holding the photo-detector;
a flexible substrate connected to the photo-detector;
an optical pickup case including a beam; and
an adhesive filling a gap between the optical pickup case and the plate,
wherein:
the beam is passed on a rear side of the detection surface of the photo-detector; and
the optical pickup case and the plate include surfaces facing each other, at least one of the surfaces including a step.

4. The optical pickup according to claim 3,
wherein the surface including the step further includes a slope.
